(19) United States
(12) Patent Application Publication
(10) Pub. No.: US 2014/0119445 A1
(43) Pub. Date: May 1, 2014

(54) METHOD OF CONCEALING PICTURE HEADER ERRORS IN DIGITAL VIDEO DECODING

(71) Applicant: LSI CORPORATION, Milpitas, CA (US)

(72) Inventors: Mizhou Tan, Basking Ridge, NJ (US); Bahman Barazesh, Flemington, NJ (US); George John Kustka, Marlboro Twp, NJ (US)

(73) Assignee: LSI Corporation, Milpitas, CA (US)

(21) Appl. No.: 13/661,675

(22) Filed: Oct. 26, 2012

(51) Int. Cl. H04N 7/26; H04N 7/32

(52) U.S. Cl. 375/240.13; 375/240.25; 375/240.12; 375/240.2; 375/E07.027; 375/E07.24; 375/E07.23

(57) ABSTRACT

A method of concealing errors in picture header information within H.263-encoded video compares current group-of-block frame identification (GFID) information to GFID information from the previous frame. If the GFID values are equal, the picture header information from the previous frame is used to decode the current frame. Otherwise, a selected parameter in the previous picture header information (for example, “picture type”) is altered and decoding proceeds with the altered picture header information. Preferably, only a portion of the current frame is initially decoded and validated prior to decoding the remainder of the frame. If the decoded portion is error-free, the decoding continues with the selected picture header information. If errors are found in the decoded portion, the picture header information is modified and the decoding process continues accordingly.

### BACKGROUND OF THE INVENTION

### Description of the Related Art

Transmission and storage of uncompressed digital video require a large amount of bandwidth. As a result, video compression is used to reduce the bandwidth to a level suitable for transmission over channels such as the Internet, wireless links and other band-limited media. Various international video coding standards, such as H.263, H.264, MPEG-1, MPEG-2, MPEG-4 and the like provide a syntax for compressing the original source video so that it can be transmitted or stored using a fewer number of bits. These video coding methods, to one degree or another, serve to reduce redundancies within a video sequence at the risk of introducing loss in quality of the decoded video. Additionally, the resulting compressed bit stream is much more sensitive to bit errors. When transmitting the compressed video bit stream in an error-prone environment, such as the IP network, the decoder at the receive end of the communication link needs to be resilient in its ability to handle and mitigate the effects of these bit errors.

In block-based estimation coders such as H.263 and H.264, transmission errors can desynchronize the coded information such that the data following an error becomes undecodable until the next synchronization code word appears. When inter-frame motion compensation is used (as employed in most current video standards), these transmission errors can continue to propagate into many of the following video frames, since inter-frame encoding uses information from other frames (such as the previous frame) to encode the current frame in an efficient, compressed fashion. Intra-frame encoding, on the other hand, uses only information within the frame itself to perform compression, making these transmission errors somewhat less of a concern.

While many techniques have been proposed to detect and conceal transmission errors, they do not address, for the most part, the problem of errors occurring within the “picture header” (PH) information at the beginning of each video frame. The few arrangements that address the problems of errors in the picture header are not considered to be satisfactory for video communication. For example, one technique is to treat the problem as a total loss of frame, with the decoder applying a “frame loss” error concealment algorithm and merely repeating the previous frame. The result is obvious visual artifacts in following frames, particularly when the motion is large or there is a scene change in the corrupted frame.

Another prior art technique is to have the decoder request retransmission of a frame that is received with a corrupted picture header. Obviously, in real-time video streaming this retransmission approach is not an acceptable solution. Additional protection can be incorporated in the original communication, for example by transmitting duplicate packets or embedding duplicate copies of the picture header information within other portions of the frame. These latter methods obviously decrease the bandwidth efficiency of the system.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In general, the invention discloses a method performed by a video decoder to conceal errors in a picture header of an H.263-encoded current frame including the steps of retrieving group-of-block (GOB) frame identification (GFID) information the current frame, comparing the GFID of the current frame to a GFID of a previous frame and if they are the same, then decoding the current frame with picture header information of the previous frame, otherwise altering a portion of the picture header information of the previous frame and decoding the current frame with the altered picture header information.

### BRIEF DESCRIPTION OF THE DRAWINGS

Other aspects, features and advantages of the present invention will become more fully apparent from the following detailed description, the appended claims, and the accompanying drawings in which like reference numerals identify similar or identical elements.

FIG. 1 is a simplified syntax for an H.263-encoded bit stream;

FIG. 2 is a flowchart of a basic technique for concealing errors in picture header information in accordance with the present invention;

FIG. 3 is a flowchart of a more detailed process for performing video picture decoding and concealment of picture header errors in accordance with the present invention;

FIG. 4 is a flowchart of an alternative process of the present invention, utilizing an additional set of steps to attempt to properly decode a picture frame in the presence of corrupted picture header information;

FIG. 5 illustrates the results of using the process of the present invention with an intra-frame encoded bit stream, where FIG. 5(a) illustrates a prior art concealment technique and FIG. 5(b) illustrates the results of using the process of the present invention; and

FIG. 6 illustrates the results of the process of the present invention with an inter-frame encoded bit steam, where FIG. 6(a) illustrates a prior art concealment technique and FIG. 6(b) illustrates the results of using the process of the present invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation”.

It should be understood that the steps of the exemplary methods set forth herein are not necessarily required to be performed in the order described, and the order of the steps of such methods should be understood to be merely exemplary. Likewise, additional steps might be included in such methods, and certain steps might be omitted or combined, in methods consistent with various embodiments of the present invention.

Also for purposes of this description, the terms “couple”, “coupling”, “coupled”, “connect”, “connecting”, or “connected” refer to any manner known in the art or later developed in which energy is allowed to be transferred between two or more elements, and the interposition of one or more additional elements is contemplated, although not required. Conversely, the terms “directly coupled”, “directly connected”, etc., imply the absence of such additional elements. Signals and corresponding nodes or ports might be referred to by the same name and are interchangeable for purposes here. The term “or” should be interpreted as inclusive unless stated otherwise. Further, elements in a figure having subscripted reference numbers, (e.g., 100₁, 100₂, . . . 100_{K} might be collectively referred to herein using the reference number 100.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Video compression standards such as H.263, H.264, MPEG-1, MPEG-2, MPEG-4 and the like achieve efficient compression by reducing both temporal redundancies between video frames and spatial redundancies within a single video frame. Each frame has associated timestamp information that identifies its temporal location with respect to some unit of time. As such, timestamps for sequential frames are represented as sequential integers and are used by the decoder to re-order the frames, since transmission through a packet network (such as the P network) does not guarantee that the frames will arrive in chronological order.

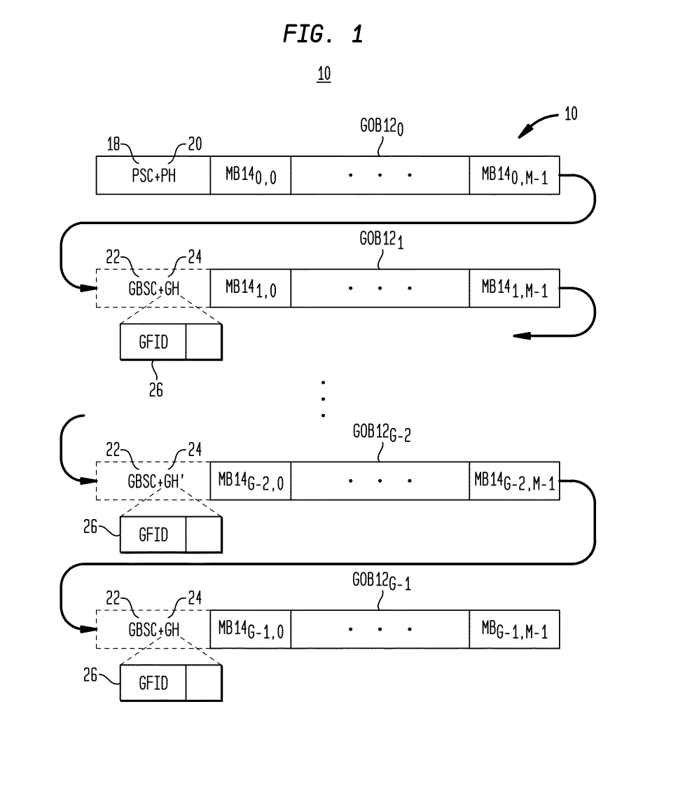

The H.263 video coding standard, incorporated by reference herein in its entirety, in particular has obtained significant attention as a result of its superior performance in low bit rate video applications, particularly with respect to its output bit rate and picture quality. In H.263, every video frame is partitioned into Groups of Blocks (GOBs), or slices, with each GOB containing multiple 16 pixel×16 pixel macroblocks (MBs). FIG. 1 illustrates an exemplary video frame 10 that has been compressed using the H.263 standard. As shown, frame 10 comprises a plurality of G GOBs 12, where each GOB 12 contains a plurality of M macroblocks MB 14. Additionally and in accordance with the H.263 standard, the initial GOB 12₀ contains an initial block 16 that carriers both “picture start code” (PSC) data 18 and “picture header” (PH) data 20.

In an optional, preferred form of H.263 encoding, each GOB 12 beyond the initial GOB 12₀ is configured to include its own “GOB start code” (GBSC) 22, followed by a GOB header (GH) 24. This is the format illustrated in FIG. 1. The addition of GBSC 22 and GH 24 ensures that an error in a current GOB 12ᵢ (where i is an integer value greater than 0 and less than G) will not affect the decoding of the next GOB 12ᵢ₊₁, even if there is a transmission loss in the middle of the current GOB 12ᵢ that renders the remaining MBs 14ᵢ in GOB 12ᵢ undecodable.

Picture header 20 is known to contain vital information about the frame, such as the timestamp, picture type (inter-frame or intra-frame), size, coding modes and quantization value, as well as miscellaneous administrative information required to correctly decode a frame. A bit error in any of the fields of picture header 20 can significantly degrade the quality of the frame. For example, errors in the timestamp information may cause the decoder to display images either in an incorrect order or not at all, possibly causing loss in synchronization with the associated audio. More severe errors may arise if picture type, coding modes or quantization options are erroneously changed. These various options in picture header information require the decoder to use special techniques, coding tables, or other configurations that will likely cause errors throughout the entire frame if the picture header is not decoded correctly. These types of errors typically manifest themselves very early in the frame and lead to the entire frame being decoded in error, even if data beyond picture header 20 is received in an error-free form.

The importance of the picture header is stressed in H.263 by providing a facility for determining changes in the picture header from frame to frame. This is accomplished by including a GOB frame ID (GFID) 26 within GOB header 24 (see FIG. 1). In one embodiment, GFID 26 is a two-bit field whose value is the same as that of the GFID in the previous frame, as long as certain important fields in the picture header have not changed. One “important field”, as will be discussed below, is the picture “type” (i.e., was the current frame created using intra-frame coding or inter-frame coding). Additionally, the GFID value remains constant in each GOB within a frame. Therefore, if the current GFID is different from the previous frame's GFID value, this indicates that information in the picture header of the current frame has changed. While indicating that the picture header information has changed, a different GFID value does not specify which particular field or fields in the picture header have changed.

In light of the importance associated with the picture header information, it is clear that errors or corruption in this portion of an initial GOB 12₀ can render the current frame (as well as following frames) undecodable.

The present invention addresses this concern and provides a method of picture header error concealment that does not require the decoder to request retransmission, drop the current frame, copy the previous frame or otherwise complicate the coding process, as was suggested in the prior art. Instead, the present invention is directed to an error concealment method that is fully carried out by the decoder with no need to involve either the encoder or the transmission channel in the process. More particularly, the method of the present invention performs a series of “best guesses” based on probability to define picture header information, and thereafter perform simple validations to see if the remainder of the frame can be properly decoded using the “guessed” picture header information. The validation takes the form of decoding only a selected portion of the current frame (e.g., the first available GOB) and then performing an error check on this decoded portion before proceeding with the remainder of the frame decoding process. The inclusion of a validation step in a preferred embodiment of the present invention allows for a continuing series of guesses to be tried if the initial guess does not properly decode a selected portion of the frame (in spite of its highest probability of success), thus preventing the entire frame from being erroneously decoded.

In many cases, a decoder using the method of the present invention is able to successfully decode the remainder of the frame with the first (or second) try at guessing the picture header information, and then conceal the initial portion that had been lost (or corrupted). The method of the present invention utilizes a low computation-complexity approach that attempts to preserve the quality of the corrupted picture to the extent possible while mitigating the artifacts present in the following pictures.

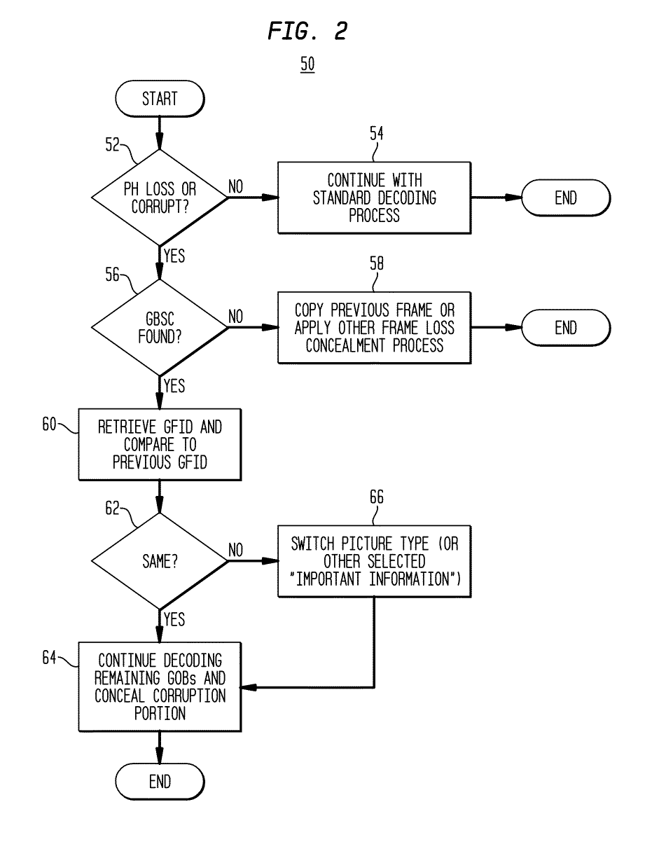

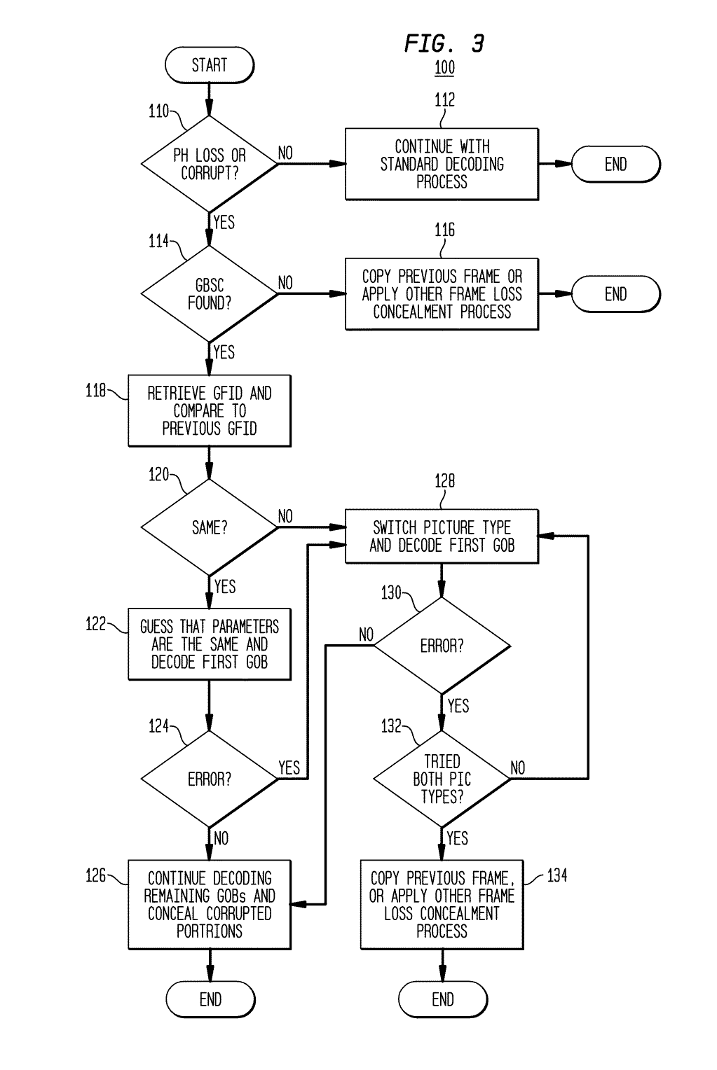

The process, as will be discussed in detail below in association with the flowchart of FIGS. 2 and 3, begins by presuming that a valid GFID has been received (even if the picture header itself is corrupted). The received GFID is then compared to the GFID of the previous frame. If they are the same, it is presumed that the picture header information (including the picture type) is also the same or sufficiently similar and the previous picture header information is selected as the “best guess” to be used to decode the current frame.

As noted above, an aspect of a preferred embodiment of the present invention is that this presumption is first validated by decoding only a portion of the current picture frame (for example, the first available GOB) and then checking the result of the decoding for errors. For example, if the wrong picture type was “guessed” and used for decoding (i.e., intra-frame instead of inter-frame, or vice versa), there is a high probability that a certain decoding error will be triggered, such as, for example, the coefficient indices of the performed discrete cosine transform (DCT) going out of bounds. An inter-frame encoding scheme and an intra-frame encoding scheme are known to use different index values, since one DCT uses information from multiple frames (for inter-frame coding) or only within the current frame (for intra-frame coding). The appearance of an out-of-bounds coefficient index can be used by the process of the present invention as an exemplary type of “decoding error” information.

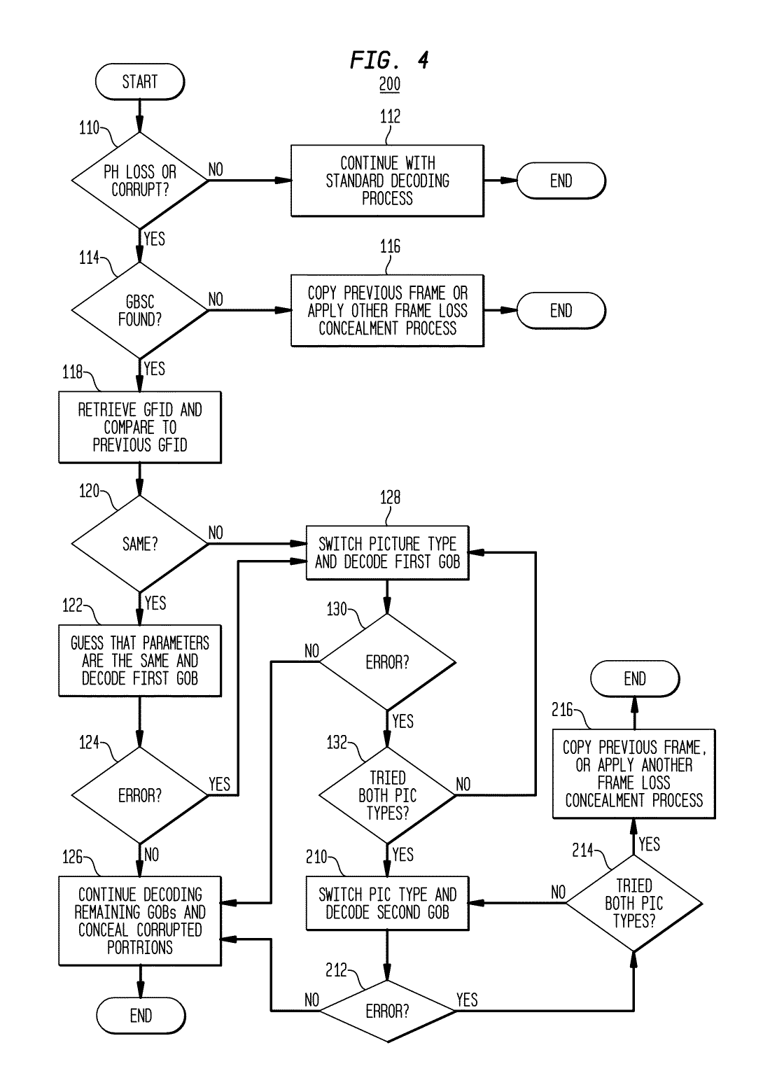

In those cases where the GFIDs of the current frame and the previous frame are different, it is presumed that a different picture type is present in the current frame, and so the alternative type (intra-frame or inter-frame, as the case may be) is used to perform the decoding. Again, only a portion of the frame is first decoded in a preferred embodiment of the inventive technique (e.g., the first available GOB) and the process validated before the entire frame is decoded with this alternative picture type. It has been found that these two processing paths are usually sufficient to properly decode most frames. However, for those cases where decoding errors are present regardless of the picture type that is used, there are additional steps that can be taken to attempt to properly decode a picture frame with a corrupted (or missing) picture header, as will be discussed in detail later in association with an alternative process flow as shown in FIG. 4.

Referring now to FIG. 2, flowchart 50 illustrates a basic exemplary process for error concealment in the presence of lost/corrupted picture header information in a H.263 coding scheme in accordance with the present invention. As shown, the process begins at step 52 by determining if the associated picture header information is either missing or corrupted for a currently-received frame. If the picture header information is intact, the conventional decoding process continues, as indicated by step 54. Presuming that some form of corruption has been found in the picture header (or that the picture header is missing), the process of the present invention is initiated with a search for a GOB start code (GBSC) in step 56. As discussed above in association with FIG. 1, the use of GBSC 22 is optional, so there may be situations where a GBSC is not found. If that is the case, the process moves to step 58, which instructs the decoder to “copy” the previous frame (or use another prior art concealment technique), since there is no other information available in the current frame that may be used to ascertain the proper picture header information.

Presuming that a GBSC is found at step 56 (which is more than likely, given that this is the preferred H.263 format), the GFID portion of the GOB header is retrieved, shown as step 60 in the flowchart. As discussed above, the GFID is typically a two-bit field whose value is the same as the GFID of the previous frame if certain important fields in the picture header have not changed. A GFID that is different from the previous frame's GFID value indicates that information in the picture header has changed. The process of the present invention uses this property of the GFID and, at step 62, compares the value of the currently-retrieved GFID to the previous GFID as known from the previous picture frame.

If the GFID values are the same, the highest probability for properly decoding the current frame is to “guess” that the picture header information is also the same. In accordance with the process of the present invention and shown as step 64, this previous picture header information is then used to decode the remainder of the frame.

Returning to the decision point at step 62 of the flowchart, if the retrieved GFID is not the same as the GFID for previous frame, the highest probability guess is that the picture type is also not the same (i.e., intra-frame instead of inter-frame, or vice versa). Generally speaking, it is presumed that a change in “picture type” is the most likely modification that would alter the GFID. However, it is possible that in specific situations other fields within the picture header could change from one frame to another and cause the GFID to change as well. Thus, while the specific steps of the inventive process as discussed below describe a flow where the picture type information is modified, it is to be understood that in its most general form, the process of the present invention may include a process of guessing another parameter of the picture header (again, starting with the highest probability) and validating and using that parameter accordingly.

Looking at decision point 62, if the result is that the GFIDs being compared are not the same, the process of the present invention proceeds to switch the current picture type with the alternative picture type (step 66) and then decode the remainder of the frame with this alternative picture type information (as well as the remainder of the information in the previous picture header).

While certainly an improvement over the prior art default methods of merely copying or dropping a frame with corrupted picture header information, this most basic approach of the present invention as outlined in the flowchart of FIG. 2 may still result in decoding errors if the initial “guess” is incorrect. Thus, a preferred embodiment of the present invention, as outlined in the flowchart of FIG. 3, includes steps to first “check” the correctness of the guess by only decoding a small portion of the frame (such as the next available GOB) and doing an error check on this portion before proceeding further.

Turning now to FIG. 3, flowchart 100 illustrates this exemplary, preferred process for error concealment in the presence of lost/corrupted picture header information in a 11.263 coding scheme in accordance with the present invention. As before, the process begins at step 110 by determining if the associated picture header information is either missing or corrupted for a currently-received frame. If the picture header information is intact, the conventional decoding process continues, as indicated by step 112. Presuming that some form of corruption has been found in the picture header (or that the picture header is missing), the process of the present invention is initiated with a search for a GOB start code (GBSC) in step 114. As discussed above in association with FIGS. 1 and 2, the use of GBSC 22 is optional, so there may be situations where a GBSC is not found. If that is the case, the process moves to step 116, which instructs the decoder to “copy” the previous frame (or use another prior art concealment technique), since there is no other information available in the current frame that may be used to ascertain the proper picture header information.

Presuming that a GBSC is found at step 114 (which is more than likely, as mentioned above), the GFID portion of the GOB header is retrieved, shown as step 118 in the flowchart. As with the process outlined in FIG. 2, this embodiment of the present invention also compares the value of the currently-retrieved GFID to the previous GFID as known from the previous picture frame (shown as step 120). If the GFID values are the same, the highest probability for properly decoding the current frame is to “guess” that the picture header information is also the same.

In accordance with this embodiment of the process of the present invention, this previous picture header information is first used to decode only a portion of the frame to validate the performance of the “guessed” information (step 122). In this case, only the first available GOB of the frame is decoded and evaluated. In this case, “first available GOB” is defined as the “first” GOB in the current frame that is fully intact (where, upon the degree of dropped/corrupted information, this may be the fourth actual GOB, or a GOB any other position within the frame). If no decoding errors are found in the first available GOB, shown as decision point 124 in FIG. 3, then it can be presumed that the picture header information from the previous frame is properly decoding the video information in the current frame and the process continues to use this picture header information to decode the remaining GOBs in the current frame (shown as step 126 in FIG. 3). As mentioned above, one indicator of a decoder error is the presence of an “out of bounds” condition for the coefficient indices of the discrete cosine transform process used in decoding. Other indicators may be used at step 124 to determine if any decoding errors have occurred, such as, for example, an “illegal output” associated with the presence of a P macroblock when intra-frame encoding is used (since P macroblocks are only used in inter-frame encoding). Other illegal outputs that may be used for error detection are associated with coded block pattern, motion vector values, etc., where in general any decoded parameter exhibit an “illegal” value for the current picture type can be considered as an error. As also shown in step 126, once the entire frame has been decoded, a conventional prior art concealment technique can be used to conceal any corrupted GOBs that were found in the initial portion of the frame.

Returning to the decision point at step 120 of the flowchart, if the retrieved GFID is not the same as the GFID for previous frame, the highest probability guess is that the picture type is also not the same (i.e., intra-frame instead of inter-frame, or vice versa). Generally speaking, it is presumed that a change in “picture type” is the most likely modification that would alter the GFID. However, it is possible that in specific situations other fields within the picture header could change from one frame to another and cause the GFID to change as well. Thus, while the specific steps of the inventive process as discussed below describe a flow where the picture type information is modified, it is to be understood that in its most general form, the process of the present invention may include a process of guessing another parameter of the picture header (again, starting with the highest probability) and validating and using that parameter accordingly.

Looking at decision point 120, if the result is that the GFIDs being compared are not the same, this exemplary embodiment of the present invention proceeds to switch the current picture type with the alternative picture type (step 128) and then decode the first available GOB using this alternative picture type. As before, only a portion of the frame (such as the first available GOB) is decoded, and then an error check is made (step 130, similar to the check made in step 124) to see if a decoding error exists. If no error is found, it can be presumed that the remaining GOBs will be accurately decoded using this alternative picture type, so the process moves to step 126.

Alternatively, if an error is detected in the decoding at step 130, the process continues with a query at step 132, asking if both picture types (inter-frame and intra-frame) have been tried. In the current process flow, the answer would be “no”, since the initial GFIDs differed and the initial picture type was switched. In association with this “no” reply, the process circles back to step 128 and the picture type is switched again (i.e., reverted back to the original picture type) and the first GOB is decoded using this original picture type information. Again, an error check is made at step 130. If this current (i.e., “original”) picture type is indeed proper, the decoding of the first available GOB will pass the error test and the decoding process will continue through step 126. If, on the other hand, there is still an error in the decoding, the process moves to the query at step 132. Since at this point both picture types have been tried, no further attempts at decoding the current frame are made, and the process moves to the step of “copying” the content of the previous frame and using it as the current frame (step 134).

One process path remains to be analyzed in the flowchart of FIG. 3. The above discussion described the path where, if the GFIDs are the same, the first available GOB is decoded without error using the prior picture header information. Returning to the decision at step 124, if a decoding error is indeed found in the first available GOB that is decoded with the prior frame's picture header, then the process of the present invention moves to step 128 to switch the picture type and attempt a decoding operation with this alternative picture type. Again, if a proper decoding of the first available GOB occurs (no errors found in step 130), then the process moves to step 126 to decode the remaining GOBs in the frame. However, if an error is found in the decoding of the first available GOB and this path goes as far as step 132, there is no circling back, since both picture types have indeed been tried. Thus, a copying operation (or an alternative concealment approach) may be used, as shown at step 134.

As mentioned above, it is possible that the process as outlined in the flowchart of FIG. 3 may fail to identify the proper picture header information required to decode the current frame if decoding errors are found upon trying both types of picture header information, as indicated by requiring step 134 to resort to “copying” the previous frame. However, in such a case, it is possible that the decoding error is not caused by wrongly-guessed picture header information, but by corruption in the GOB being decoded. FIG. 4 illustrates an alternative, extended process 200 that may be used in accordance with the present invention to perform additional testing to attempt to define the proper picture header information that is required to decode the current frame before resorting to merely copying the previous frame.

As shown in FIG. 4, the initial section of process 200 is identical to the steps followed in the basic method 100 of the present invention as outlined in FIG. 3. However, process 200 is shown as including an additional set of steps to use should both picture types fail to properly decode the first available GOB. In particular, if process 200 reaches the point at the end of decision step 132 that both picture types have been tried and have failed to properly decode the first available GOB, the next step (shown as step 210) is to switch back to the originally-tried picture type (which is, presumably, more likely to be the correct type) and now decode the “second available” GOB with this original picture type. It is quite possible that if the first available GOB is corrupted, the initial attempt at decoding will generate errors at step 124, regardless of the validity of the picture type being used. Thus, this extended process of the present invention as illustrated in FIG. 4 will reach into the next available GOB and again attempt to decode this frame using the same process as outlined above.

Similar to the process described above, a check is made to see if there is an error present in the decoding of the second available GOB using the originally-selected picture type (step 212). If no errors are detected, the process moves to step 126 and, as before, decoding of the remaining GOBs continues with this original picture type. At the completion of the decoding process, a conventional concealment technique can be used, as mentioned above, to conceal the errors those GOBs that were not decoded properly (such as those occurring during the decoding of the remaining GOBs after guessing the correct picture type—which may be caused by individual MB corruption). That is, the picture header concealment technique of the present invention is considered as useful as an additional tool in performing accurate decoding, and does not displace the use of conventional concealment techniques created to address MB errors, or other errors within the frame itself.

Returning to step 212, if an error is detected in the decoding of the second GOB, the process continues with performing a check to see if both picture types have been tried (step 214). In this case, the answer is “no”, so the process circles back to step 210 and the second GOB is decoded using the alternative picture type. Again, an error check is made at step 212, with the result either being that no errors are found and the remaining portion of the frame continues to be decoded (step 126) or, alternatively, the process moves through the check at step 214 and then to the final operation at step 216, where the previous frame is copied and used (or, as mentioned above, another prior art concealment technique is tried).

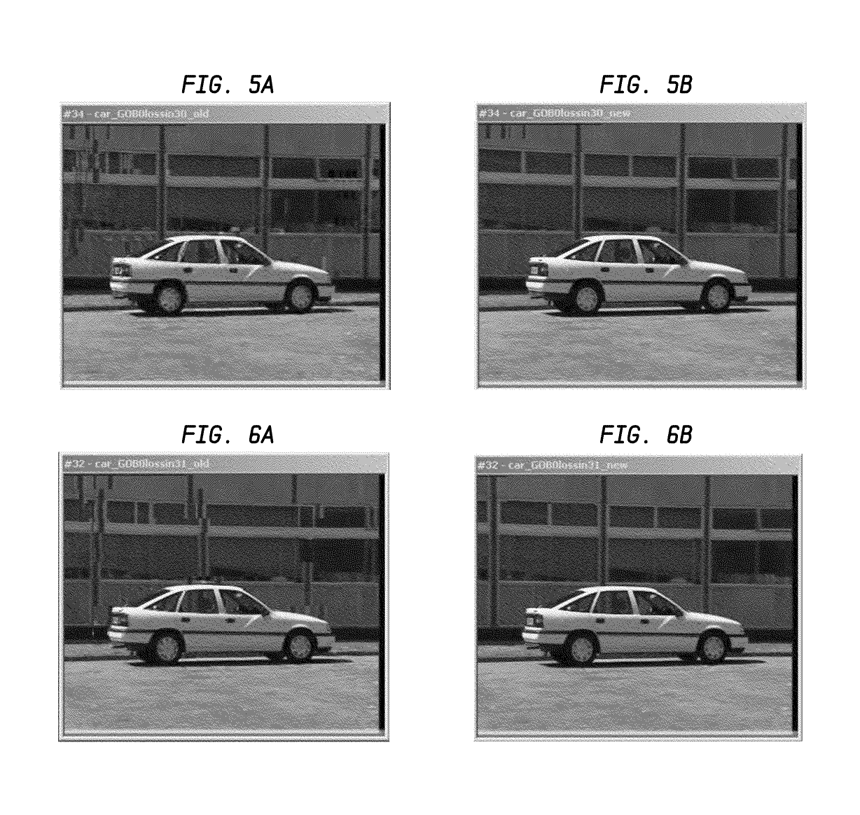

FIGS. 5 and 6 illustrate different simulations where the process of the present invention has been used. FIG. 5 is associated with a picture header concealment process as used in an intra-frame embodiment where a picture header loss occurs in the thirtieth intra frame. FIG. 5(a) shows the thirty-fourth frame as generated using a prior art frame-loss concealment process (here, the twenty-ninth frame is copied and used as the thirtieth frame). Artifacts associated with the picture header loss are clearly evident in the upper left-hand area of this frame, as a result of error propagation from one frame to another. In contrast, FIG. 5(b) shows the same thirty-fourth frame, in this case generated using the picture header concealment process of the present invention to conceal the picture header error in the thirtieth frame. The picture quality is quite good in this case, with only a slight distortion in the top-left corner of the frame.

FIG. 6 illustrates the improvement when applying the method of the present invention to an inter-frame coded picture. Here, FIG. 6(a) shows the thirty-second inter frame of a video where the picture header was lost in the thirty-first inter frame. The distortion is quite apparent as a “ripple” across the entire frame. In contrast, the same frame as encoded using the inventive picture header concealment technique is quite clear, as shown in FIG. 6(b).

In summary, it has been clearly described and demonstrated that the novel error concealment process of the present invention fully handles picture header error within the decoder, without requesting any actions to be performed at the packet level or on the encoder side. The method of the present invention does not sacrifice the bandwidth efficiency, cause extra delay or increase encoder complexity, while remaining totally compliant with the H.263 standards.

While the methodology of the present invention as outlined above uses alternative values of the picture header parameter of “picture type” to perform the decoding and validation process, it is to be understood that other parameters (fields) within the picture header may be used if particular circumstances indicate that another parameter (e.g., coding method, quantization, or the like) may have been corrupted or lost during transmission. Additionally, while the method as described in association with FIGS. 3 and 4 relates to an exemplary process where a “first available GOB” is decoded and validated before decoding the remainder of the frame, it is possible other segments (longer or shorter) may first be evaluated, if an initial checking of the guessed parameter is used.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention.

Indeed, the present invention can take the form of a processor for decoding H.263-encoded frames that is configured to receive a current H.263-encoded frame and determine if the current frame has corrupted picture header information. If it is determined that the picture header is corrupted, the processor is further configured to retrieve the GFID from the current frame and compare it to the GFID of a previous frame and if they are the same, proceed to decode the current frame with picture header information of the previous frame. Otherwise, the processor is configured to alter a portion of the picture header information of the previous frame and decode the current frame with the altered picture header information.

The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A method of decoding a current H.263-encoded frame in the presence of corrupted picture header information:
retrieving group-of-blocks frame identification information from the current frame;
comparing the group-of-blocks frame identification information of the current frame to a group-of-blocks frame identification information of a previous frame and if they are the same, decoding the current frame with picture header information of the previous frame, otherwise
altering a portion of the picture header information of the previous frame and decoding the current frame with the altered picture header information.

2. The method as defined in claim 1 wherein the portion of picture header information that is altered is the picture type information.

3. The method as defined in claim 2 wherein the picture type information is altered between the values of inter-frame encoding information and intra-frame encoding information.

4. The method as defined in claim 1, wherein the method performs error checking during decoding and includes the additional steps of:
decoding a portion of the current frame; and
continuing the decoding process if the portion is decoded error-free, otherwise altering a portion of the picture header information and re-initiating the decoding process.

5. The method as defined in claim 4 wherein the decoding is defined as error-free if a coefficient index for a discrete cosine transform of the decoded portion of the current frame remains within a predetermined value.

6. The method as defined in claim 4 wherein the decoding is defined as error-free if a decoded macroblock type is permitted for the current picture type information.

7. A method performed by a video decoder to decode a current H.263 frame in the presence of corrupted picture header information:
a) retrieving group-of-blocks frame identification information from the current frame;
b) comparing the group-of-blocks frame identification of the current frame to a group-of-blocks frame identification of a previous frame and if they are the same, selecting picture header information of the previous frame to use for decoding, otherwise altering a portion of the picture header information of the previous frame and selecting the altered picture header information to use for decoding
c) decoding a portion of the current frame using the selected picture header information from step b);
d) continuing to decode the remainder of the frame using the selected picture header information if the decoded portion of step c) is error-free, otherwise,
e) altering the picture header information and again decoding the portion of the frame;
f) continuing to decode the remainder of the frame using the altered picture header information, otherwise performing steps e) and f) until all options have been tried or the decoding has been completed, where if all options have been tried and decoding is not error-free, copying the previous frame as the current frame.

8. The method as defined in claim 7, wherein in performing step c), a first available group-of-blocks is selected as the portion of the current frame to be decoded.

9. The method as defined in claim 7, wherein in performing step c), a picture type is used as the selected picture header information.

10. The method as defined in claim 9 wherein the picture type comprises alternative values of intra-frame coding and inter-frame coding.

11. The method as defined in claim 7 wherein in performing step f), the process contains the additional step of:
g) prior to copying the previous frame, repeating steps c) through f) using a different portion of the current frame to be decoded and evaluated.

12. The method as defined in claim 11 wherein in performing step c), a first available group-of-blocks is selected as the portion of the current frame and in performing step g), a second available group-of-blocks is selected as the different portion of the current frame.

13. The method as defined in claim 7 wherein in performing step d), defining the decoding as error-free if the coefficient index for a discrete cosine transform of the decoded portion of the current frame remains within a predetermined value.

14. The method as defined in claim 7 wherein in performing step d), defining the decoding as error-free if a decoded macroblock type is permitted for the current picture type information.

15. A processor for decoding H.263-encoded frames, the processor configured to:
receive a current H.263-encoded frame;
determine if the current frame has corrupted picture header information, and if so the processor is further configured to:
retrieve group-of-blocks frame identification information from the current frame; and
compare the group-of-blocks frame identification information of the current frame to a group-of-blocks frame identification information of a previous frame and if they are the same proceed to decode the current frame with picture header information of the previous frame, otherwise the processor is configured to alter a portion of the picture header information of the previous frame and decode the current frame with the altered picture header information.

16. The processor as defined in claim 15 wherein the processor is further configured to:
perform error-checking by decoding a portion of the current frame;
determine if the portion has been decoded error-free and, if so, continue to decode the current frame, otherwise, if errors are found, the processor is further configured to alter a portion of the picture header information and re-initiate the decoding process with the altered picture header information.
